(19) United States
(12) Patent Application Publication
(10) Pub. No.: US 2006/0277056 A1
(43) Pub. Date: Dec. 7, 2006

(54) Method and apparatus for candidate evaluation

(75) Inventor: Orrin R. Broberg, Edina, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(73) Assignee: Net Intent LLC

(21) Appl. No.: 11/144,874

(22) Filed: Jun. 3, 2005

(51) Int. Cl. G06Q 99/00

(52) U.S. Cl. 705/1

(57) ABSTRACT

The present invention, in one embodiment, is a system for assisting in evaluating candidates for jobs, advancement, training or other business association. The system has a program component defining a plurality of selection profile factors, each with a set of two or more responsive characteristics associated with a candidate; and a program component defining a scoring schema associated with each set of two or more responsive characteristics, each responsive characteristics having an associated scoring value Sij based on intrinsic knowledge. The system additionally has a program component for defining a weighting vector containing a weighting value Wi for one or more of the plurality of selection profile factors and a program component for accessing data representing responsive characteristics of one or more candidates for the plurality of selection profile factors. Further there is a program component for developing an evaluation of each candidate's responsive characteristics relevant to the selection profile factors, said evaluation comprising determining scoring values associated with the candidate responsive characteristics and applying to the determined scoring values a weighting value corresponding to the selection profile factor, then aggregating for each candidate the resulting weighted scoring values for each responsive characteristic of such candidate.

### BACKGROUND OF THE INVENTION

The present invention relates to computerized apparatus and methods for evaluating job candidates, advancement or training candidates and business associates. More specifically, the present invention relates to a system for collecting and processing data on persons (or entities) to evaluate their suitability for particular jobs specified by a hiring party or for advancement, training or business associations.

Evaluation of persons to be hired can be difficult. The candidate population is usually very diverse in its characteristics. Hiring parties may not have the same view of the best qualifications for a particular job title. If multiple interviewers are involved, each may have a different set of criteria in mind, a different way of eliciting information from candidates and a different way of evaluating the information candidates provide. Some interviewers or evaluators of resumes have insufficient experience for good judgments. Thus, it can be difficult for an organization or a hiring consultant to have a systematic and consistent approach to collecting candidate information and evaluating it. This is particularly difficult when there are large numbers of candidates, making comparisons difficult.

There exist computer-based systems for assisting personnel searches. One known approach uses a traditional database that is populated with profile information obtained from an automated interview or other similar sources that permit tables of applicant characteristics to be built. SQL queries are used to select particular applicants from a pool of applicants kept in the database. The system may use initial “Must have” criteria to select a subset of applicants. This is done with traditional database commands. Any applicant not fully meeting all the “Must Have” criteria is at that point eliminated. The potential hiring party can then apply a set of “Nice to Have” criteria with weighting factors. Each of the applicants in the subset is tested for each of the “Nice to Have” criteria. If they meet a criterion, they are assigned the weighted score for that criterion. If they do not fully and exactly meet the criterion, they are not assigned any score from that criterion. Such a system has no ability allowing it to determine how far the applicant is from the requested criteria.

After all subset applicants have been checked, the ones that have received scores over some threshold may be reported to the hiring party. This could be none (if the criteria are too restrictive) or too many (if the criteria are too loose). It is solely up to the hiring party to determine criteria that will produce a useful selection. The selected applicants are those that receive the highest score, but are not necessarily “best” in an overall sense. Some that are actually good candidates might have been eliminated by overly restrictive criteria. Also, the scoring scheme may not be well-enough calibrated to reflect the true value of a candidate's characteristics relative to the characteristics the hiring party considers ideal.

Thus, there is a need for improved job candidate evaluation systems and methods that assist the hiring party in finding the best candidates. Evaluation of large groups of candidates for advancement or for specialized training or entities for certain business associations, such as distributor relationships, poses much the same issues as evaluations for hiring. Here, too, the evaluation systems and methods need improvement.

### BRIEF SUMMARY OF THE INVENTION

The present invention, in one embodiment, is a computer implemented system for assisting in evaluating candidates comprising: a program component defining a plurality of selection profile factors, each with a set of two or more responsive characteristics associated with a candidate; a program component defining a scoring schema associated with each set of two or more responsive characteristics, each responsive characteristics having an associated scoring value Sij based on intrinsic knowledge; a program component for defining a weighting vector containing a weighting value Wi for one or more of the plurality of selection profile factors; a program component for accessing data representing responsive characteristics of one or more candidates for the plurality of selection profile factors; and a program component for developing an evaluation of each candidate's responsive characteristics relevant to the selection profile factors, said evaluation comprising determining scoring values associated with the candidate responsive characteristics and applying to the determined scoring values a weighting value corresponding to the selection profile factor, then aggregating for each candidate the resulting weighted scoring values for each responsive characteristic of such candidate. Another embodiment comprises the method carried out by the aforementioned system.

The present invention, in a further embodiment, is a computer readable medium with computer programs that implement the aforementioned system and method.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the spirit and scope of the present invention. Accordingly, the drawings and detailed description are to be regarded as illustrative in nature and not restrictive

### BRIEF DESCRIPTION OF THE DRAWINGS

FIG. 1 is a schematic block diagram of a system for evaluating candidates for hiring.

FIG. 2 is an example listing for a particular job of selection profile factors or criteria and available candidate responses for such factors.

FIG. 3 is a table showing the exemplary selection profile factors of FIG. 2, with an associated generalized scoring schema that incorporates intrinsic knowledge and with weighting.

FIG. 4 is a flowchart showing the steps for using the present system for evaluating a pool of candidates for a particular job.

FIG. 5 is a table showing a portion of a sample scoring schema.

FIG. 6 is an example of output after candidate evaluation under a scoring and weighting schema.

FIG. 7 is a screen shot showing how intrinsic knowledge may be entered and organized for a given set of employer requirements that may be used for multiple jobs.

FIG. 8 is partial screen shot showing a control panel for selecting or revising evaluation parameters.

### DETAILED DESCRIPTION

Overview. The present system uses an expert system approach relying on an underlying inference engine and heuristic rules to make selections from a pool of candidates for a job, for advancement or training or for some form of business association, such as a distributor or channel partner. The following description focuses on job candidate selection, but shows a system usable for other, comparable multi-factor selection activities.

The approach of the present system is in contrast to a traditional database approach. The system logic and rules are first built by an expert in the field of selecting employees for the particular employment category (e.g., sales of telecom products) and/or knowledgeable about a company's hiring policies. This logic is defined using If/Then rules and other logic diagrams as needed by the expert system development tool. The result is an expert system that has intrinsic knowledge and rules that allow it to determine how closely an applicant matches particular target criteria. For a simple example, if one criterion is that the applicant live within a 30 mile radius of an office, and the candidate actually lives 31 miles away, the system is configured with the knowledge and ability to recognize that 31 is very close to 30. (In an inflexible evaluation, if the 30 mile criteria was not met, the applicant would be eliminated or penalized regardless of how little over 30 the actual value was). Likewise, in the present system, if the employer specifies a particular desired type of experience, training or certification, the expert system would be able to examine the applicant's experience, training or certification data to find characteristics that are relevant to the criteria and rank them according to how closely they match the ideal candidate characteristic.

This expert system is designed to embody broad knowledge of the applicant selection process for the specific job type. It is not limited to a particular job selection, and can be used by many different employers with different criteria for the specific position they are filling, provided they are within the domain covered by the expert system rules and knowledge. It provides the interface to the employer to select the specific criteria and weightings that are important to that employer for a particular job. As used herein “job” can mean any form of engagement where the characteristics of the person or entity engaged (or contracted with) are important enough to select with reasonable care among the applicants. This includes full or part time employment positions, consulting engagements, distributor or other business associations, volunteer assignments and other relationships in which the hiring or selecting party needs a good or best possible match to the requirements of the job.

Once the criteria or selection factors for a job domain have been defined, the hiring party then can use the expert system to find the best applicants. The hiring party defines a profile of the “ideal” applicant. (This can be very precise, because the knowledge in the system rules will automatically measure “best fits” rather than having overly restrictive criteria that eliminate based on a failed match.)

The present system then takes the employer's “ideal” profile and compares it against characteristics of each of the applicants in the database. This is done using traditional expert system techniques, with an underlying inference engine using the knowledge and rules in the system to rank how well each applicant matches the ideal profile. For each criterion in the profile, the knowledge and rules in the system provide a score based on the expert's opinion as to value of a candidate's own characteristic or attribute relative to the desired (ideal) characteristic or attribute. One view of this is think in terms of “proximity” to the ideal characteristic. The measure of proximity for each criterion is defined by the stored domain (or intrinsic) knowledge in the form of a scoring schema. The “proximity” score determined for a particular candidate and characteristic is then multiplied by a weight factor (generally) provided by the employer indicating how important this particular criterion is in the selection. The combination allows the employer to indicate a preference, but it is balanced by the expert knowledge contained in the rules, the scoring schema.

When all applicants have been checked, the system will produce a list of the top applicants that best meet the profile. The system designer (or hiring party) controls the exact number of applicants presented after evaluation of the candidate pool by specifying an adjustable report limit. Assuming an adequate pool, the system always will report that selected number. This is unlike earlier approaches, where a sparse database or restrictive criteria would be likely to produce few or no selections. In the present approach, even if no applicant exactly meets all (or even any) of the ideal criteria, the “best” matches will still be selected and displayed. In addition, the present system can provide an applicant-specific report on each selected applicant detailing how well he/she matches (or does not match) the specified “ideal.”

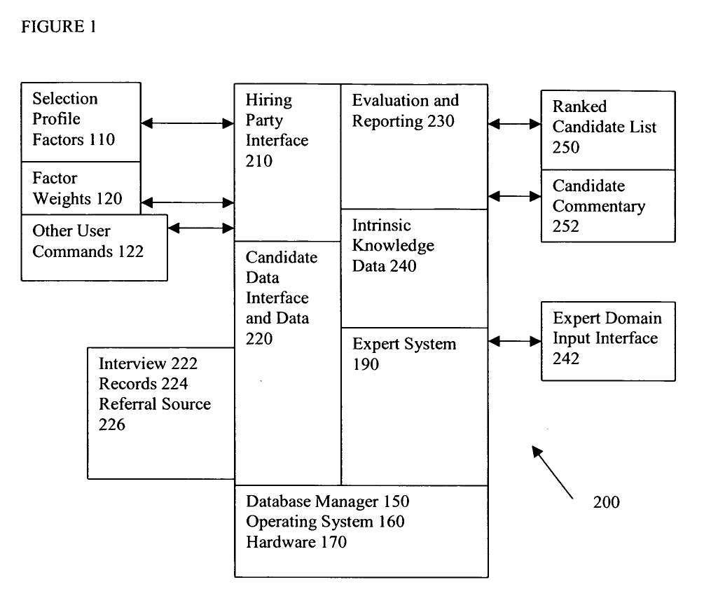

Basic Elements of System. FIG. 1 is a schematic block diagram of a system 200 for implementing the above principles. The system is built on a general purpose computer with processor hardware 170 and, in various forms of memory, software components, including an operating system 160 and a database manager 150 for storing candidate data and other data used in the evaluation system. There are various other software components used to implement the system. There is a hiring party interface 210 used to receive information describing the profile of persons hiring parties may wish to hire, including data inputs for selection profile factors (or criteria) 110, factor weights 120 and other user commands 122. There is also a candidate data interface and data file 220 that can receive data from interviews 222 (which may be done interactively on-line), previously stored personnel records 224 and referral sources 226 (such as placement offices or other agents acting on behalf of candidates).

Other software components implement other specific functionality of the system 200. An expert system 190 is used as a platform for constructing the evaluation logic. For example, the Exsys Knowledge Automation Expert System, available from Exsys, Inc., of Albuquerque, N. Mex. is a suitable platform into which domain knowledge on the job/position domain and on company policies or other knowledge used for candidate evaluation can be loaded. Using expert domain input interface 242, the system creates a data structure or data base file of intrinsic knowledge 240 that is accessed by evaluation and reporting software components 230. In addition to controlling the evaluation, these components produce the results that reflect the evaluation processing. These may, for example, output a ranked candidate list 250 and/or a candidate commentary 252.

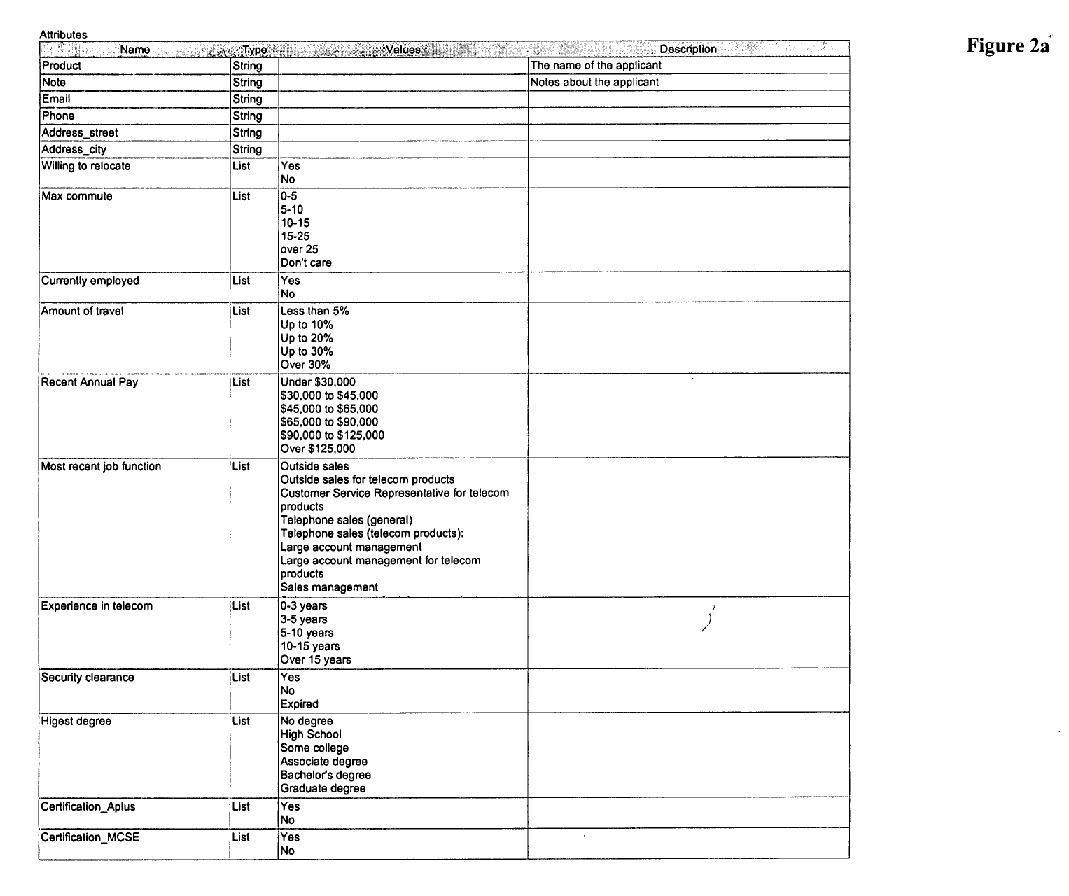

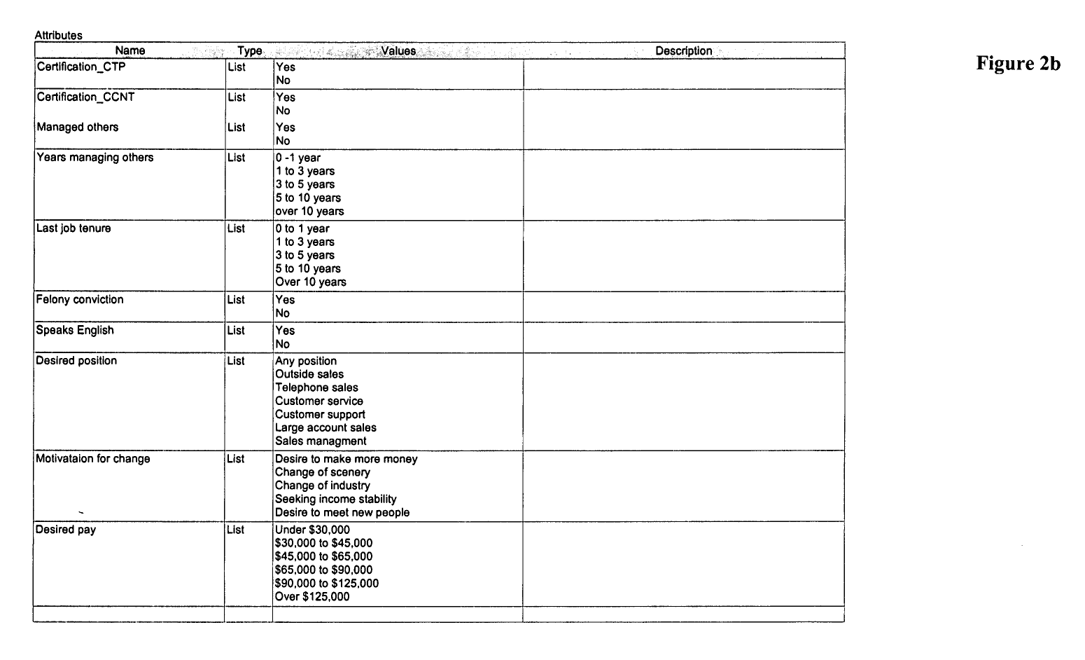

Evaluation Rules/Intrinsic Knowledge. To begin a candidate evaluation process, the hiring party must first develop a list of selection profile factors (or criteria). FIG. 2 shows an example of such a list that can be used as input to the system. The chart of FIG. 2 shows in the first six rows fields for certain string data. Below those rows in the first column (“Name”) appear factors that in the hiring party's view are relevant for a particular job. These include: willing to relocate; the maximum commute a candidate will accept; current employment status; the amount of travel a candidate will accept; most recent annual pay; most recent job function, experience in telecommunications; security clearance, highest degree; one or more certifications, and so forth.

In the second column is the data “Type”. In the third column are two or more possible candidate responsive characteristics (attributes) that may be selected by a candidate in response to a query about each of the factors (or pre-existing in an accessible record). As mentioned above, the system 200 employs an expert system that has been loaded with intrinsic knowledge and rules that allow it to determine how closely an applicant matches a particular selection profile factor. One aspect of setting up the proximity measurement is to define in the set of responsive characteristics (or attributes) available for selection not only the exact desired profile criterion but also some responses that represent alternative characteristics that a candidate might have. The set of responses defined for possible selection are designed to provide a scale on which proximity to the ideal characteristic (as defined for this job) can be measured. Thus, some responses may represent close and useful alternatives relative to the ideal characteristic and other responses may represent distant and/or non-useful alternatives. Using expertise to define response alternatives useful for categorizing distinguishing characteristics/attributes is part of what enables effective proximity measurement among candidates.

These responses representing the characteristics for any particular candidate may be received from a candidate in a variety of ways. One way of doing this is to provide the candidate an interactive screen presenting the various factors and prompting use of a dropdown menu for each factor to view and select the alternative that is the candidate's response and that will ultimately be used for the proximity measurement. Thus, referring to FIG. 2, in response to “max. commute”, the candidate will select one of the six alternatives listed in the third column and, for example, in response to “Currently employed” will select either yes or no, as listed in that row. FIG. 2 shows a set of about twenty selection profile factors. As can be understood, the set of selection profile factors can be as long as necessary and is limited only by practical considerations in collecting the responses from candidates. Also, the set of responses for a factor may have two, three, four, eight, etc. selections and be as large as needed to map out likely candidate characteristics, although again there are practical limits in making a usable instrument for eliciting candidate responses.

Candidate responsive characteristics may also be obtained from a placement agent who is familiar with a candidate's background or, in the case of internal or previously known candidates, from the records that an organization may keep on employees, former employees and consultants. Thus, a responsive characteristic means one responsive to a selection profile factor, whether or not the candidate himself/herself provides a response directly to the system.

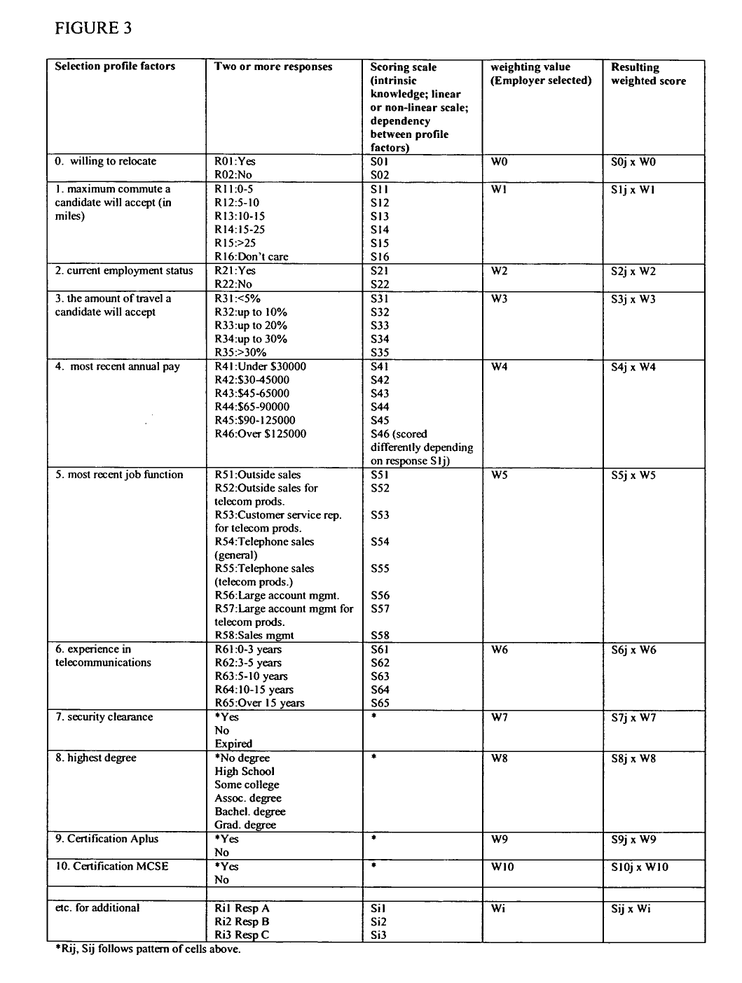

FIG. 3 shows in the first two columns the same selection profile factors and responses as in the first few rows of FIG. 2. Here each factor has an associated set of responses Rij. For example, Factor 0 (willing to relocate) has response set R01=Yes, R02=No, and Factor 1 (max commute) has R11=0-5 miles, R12=5-10 miles, etc. However, FIG. 3 also introduces the flexible scoring schema and weighting that were discussed above. As seen in the third column, the system associates with each response for the selection factor number 1 a scoring value S1j, where j ranges from 1 to 6 and each R1j has an associated scoring value S1j. For the “max commute” factor, the set of values {S11, S12, S13, S14, S15, S16} may be chosen so that it is roughly linear, with increasing scores given for greater flexibility shown, e.g., {S11=1, S12=2, S13=3, S14=4, S15=5, S16=6}. This may be based on judgments embodied in expert inputs from interface 242 that may be prepared at the same time as the set of possible responses. However, it will be seen that if research (or a different expert's judgment) establishes that greater flexibility is increasingly valuable only up to a point, the set of values input or derived from expert input might be {S11=1, S12=2, S13=3, S14=3, S15=3, S16=3}. Thus, this kind of intrinsic knowledge could shape the scoring schema for the proximity measurement for this factor.

The Recent Annual Pay factor might make use of association of certain candidate responses with a negative scoring value. For example, with a job that would pay $50,000 annually, an expert might conclude that a person who has recently made significantly more money might take a job but typically would continue looking for an even higher paying position and thus would offer poor stability for the position to be filled. Thus, for a given job paying $30,000 to $45,000 annually, candidates responding in the top two salary levels, could earn negative scores with a set of associated response values such as: {S41=1, S42=2, S43=3, S44=4, S45=(−2), S46=(−5)} Thus, again, particular kinds of intrinsic knowledge can shape the scoring schema for this factor.

The “Most Recent Job Function” is a factor where intrinsic or expert knowledge is useful, because proximity to the ideal most recent job function may be difficult to judge or measure. Here experienced personnel judgment and/or research may define a set of responses and a corresponding set of scoring values for a scoring schema that has no mathematically or logically neat pattern. There may be the same scoring values associated with different responses; there may be negative score values; there may be a very non-linear set of values across the scoring schema, e.g., {S51=2, S52=2, S53=3, S54=(−4), S55=(−2), S56=5, S57=4, S58=7} (assuming eight possible responses). While the present example shows just one level for job function, it is also possible to make this inquiry more granular by focusing on different industry sub categories and multiple, more specific functions of any given job. Then this criterion would be evaluated via multiple factors, each with its own scoring schema.

Thus, the scoring schema will be designed to yield the highest score on each factor to a person whose characteristic on each factor fits exactly the profile of the ideal candidate. Other candidate characteristics will receive lesser scores, calibrated to reflect as much intrinsic knowledge as can be applied to the scoring schema. Some responses may be associated with a negative score that results in an effective penalty, reducing the value of good scores on other factors.

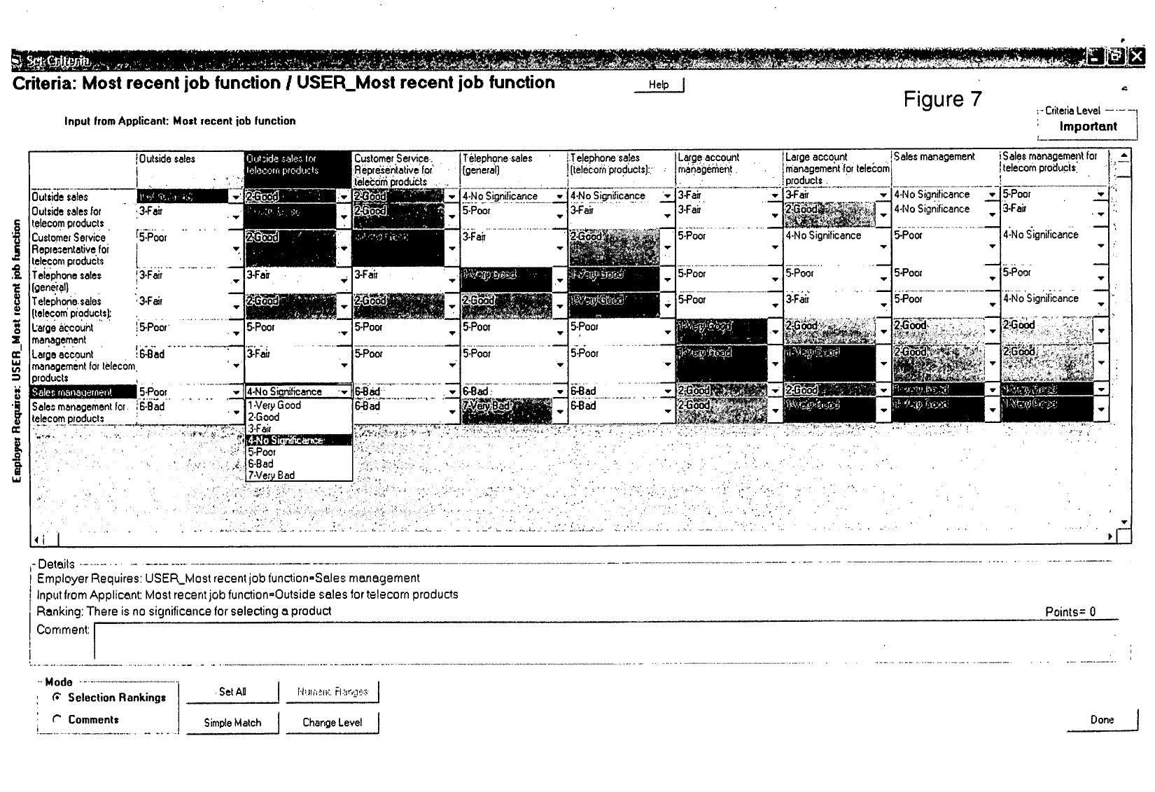

FIG. 7 shows a screen shot of a matrix that allows collection of intrinsic knowledge on the selection profile factor “Most recent job function”, as an example. In FIG. 7, the leftmost column lists possible hiring party requirements, i.e., characteristics (here, job functions) that might be selected as ideal for certain telecom industry jobs. The topmost row lists these same characteristics as possible candidate responses to an inquiry. Thus, the diagonal of the matrix represents an exact match, always evaluated at the highest level on the available scale (here, ranging across seven levels from “very good” through “no significance” to “very bad”). The person providing expert/intrinsic knowledge for this evaluation schema (via expert domain interface 242, FIG. 1) will select one of the seven available categories presented by a dropdown menu (see FIG. 7, column 3). This judgment in selection makes the important proximity or value judgment about a candidate's suitability based on this selection factor. For example, if the ideal is “customer service representative for telecom products”, both “outside sales for telecom products” and “telephone sales (telecom products)” will be ranked “good”. Other possible candidate responses (characteristics) rank “fair”, “poor” or “bad”.

Such matrices as in FIG. 7 are one step in automating the documentation of intrinsic knowledge into stored data structures that become the logic of the software components performing evaluation. As can be seen, the matrix captures intrinsic knowledge relevant to each of the positions listed in the leftmost column. It is thus useful for multiple job selections.

With the qualitative rankings captured in the matrix of FIG. 7, the system builder may now associate any suitable qualitative scores, Sij. As noted above, these may be positive or negative and may range linearly or non-linearly from highest to lowest. The particular numerical values chosen reflect further intrinsic knowledge.

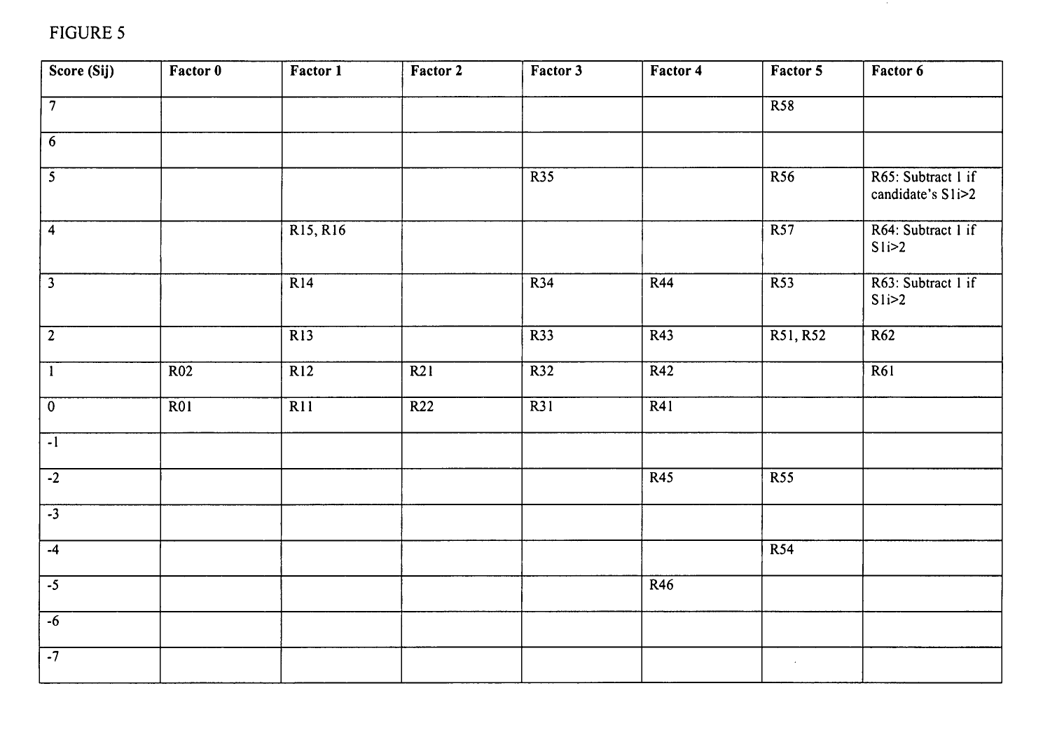

FIG. 5 is a table that schematically depicts a simplified set of factors and response characteristics in a scoring schema as generally shown in FIG. 3. As seen in the table of FIG. 5, this scoring schema permits scores over the range {−7, +7}. For each factor in the table {Factor 0, . . . Factor 6}, each of the possible responses {Ri1, Ri2, Ri3, . . . }is placed in a cell that is associated with a score on the scale {−7, +7}. The various factors demonstrate several possible scoring schema based on intrinsic knowledge of the factor in the particular job domain. Factor 0: simple yes/no alternatives, only one of which provide the candidate any scoring value; Factor 1: a simple linear increase in scores across the range or responses, except that either of two responses can yield the highest available score of 4; Factor 2: simple yes/no alternatives, but scored value may be reversed as compared to Factor 0; Factor 3: a generally linear scoring range with zero or positive values; Factor 4: a highly non-linear scoring range, with positive and negative values; Factor 5: another a highly non-linear scoring range, with positive and negative values and two responses associated with the same score.

In one possible scoring schema, the scoring value associated with a particular characteristic is not a constant taken from the range {−7,+7} but rather could be made a function of another candidate characteristic. That is, for example, if it were noted that one of more responses in FIG. 3, factor 1 (maximum commute) should be linked to one or more responses in factor row 4 (most recent annual pay), a value S4j could be responsive to or a function of a value S1j. This approach can be seen in the table of FIG. 3, where S46 is noted as scored differently depending on the characteristic selected for S1j. For example, S46 might be reduced (or increased) by the value S1j.

Another example might be a form of psychometric adjustment, whereby the value associated with a candidate's response may be adjusted to account for a discernible reporting bias. The candidate characteristics evaluated by the system are necessarily those reported to it by the candidate or another information source. With suitable psychometric analysis of candidates and sources, it may be found that certain response data need discounting due to likely “puffing” by the candidate or source that can be detected from another response or pattern of responses. Conversely, undue modesty might also be discernible from one or more responses. In reaction, one or more scores on a scale might receive upward adjustment by reason of responses on another scale that suggest a modesty bias. Factor 6 of FIG. 5 shows how a cell in the scoring table might be used to cause such a correction on a conditional basis. Here three cells are annotated with a conditionally applied adjustment by one point. For two cells, no adjustment is indicated. This is another way in which intrinsic knowledge surrounding a particular job or range of jobs and knowledge of the application process within a domain might be implemented in a scoring schema. Use of a sophisticated expert system permits such dependencies to be implemented by suitable If/Then or other logic operating in the scoring schema. FIG. 5 is just one example of how a scoring schema might be organized and implemented. It affords considerable flexibility and complexity for implementing intrinsic knowledge of useful metrics for comparing specific candidate characteristics.

It is also possible to allow for any given factor two or more responses and to apply a score for each of certain responses. For example, in a factor based on education (not just highest degree), a candidate might respond that he/she has both an associate degree and a bachelor's degree. This candidate could be awarded points for both responses by appropriate scoring schema logic.

While it may be useful to involve a hiring party in design of a scoring schema, sophisticated design of scoring schema may involve expertise available only in the most sophisticated human resources departments. Thus, in many cases the intrinsic knowledge in scoring schema may come entirely from domain experts, and users will trust that these schema are well-constructed. However, the hiring party still needs to have an opportunity to include its preferences in the evaluation process.

Accordingly, referring again to FIG. 3, in addition to intrinsic knowledge used to guide response scoring, the system permits a hiring party to emphasize some factors more than others in evaluation. Thus, the “most recent job function” might be viewed as significantly more important than the “max commute”. The system permits the hiring party to assign a weighting factor Wi (shown in the fourth column of FIG. 3) to one or more rows. (For some factors, it may be useful to fix the weighting value at unity (“1”), so that no special weight is assigned. In other applications, all rows/factors will have a selectable weighting. As further seen in the fifth column, the scored value resulting from the scoring schema is then weighted by a weighting factor applied to the score developed by application of the scoring schema. For example, the weight can be applied as a simple multiplier, Wi×Sij, although other mathematical approaches to weighting values are also possible, and could be derived from theory or from empirical work. With the exemplary multiplier form of weighting, the total score for a candidate's set of responses can be computed as:

Score for Ranking=sum of weighted individual factor scores=(S1j×W1)+(S2j×W2)+ . . . +(Sij×Wi) . . . , where the S1j, S2j, etc. are the scores assigned for each profile selection factor according to a candidate's characteristics and the scoring schema incorporating intrinsic knowledge. Other methods of aggregating the weighted scores as known to statisticians are also possible.

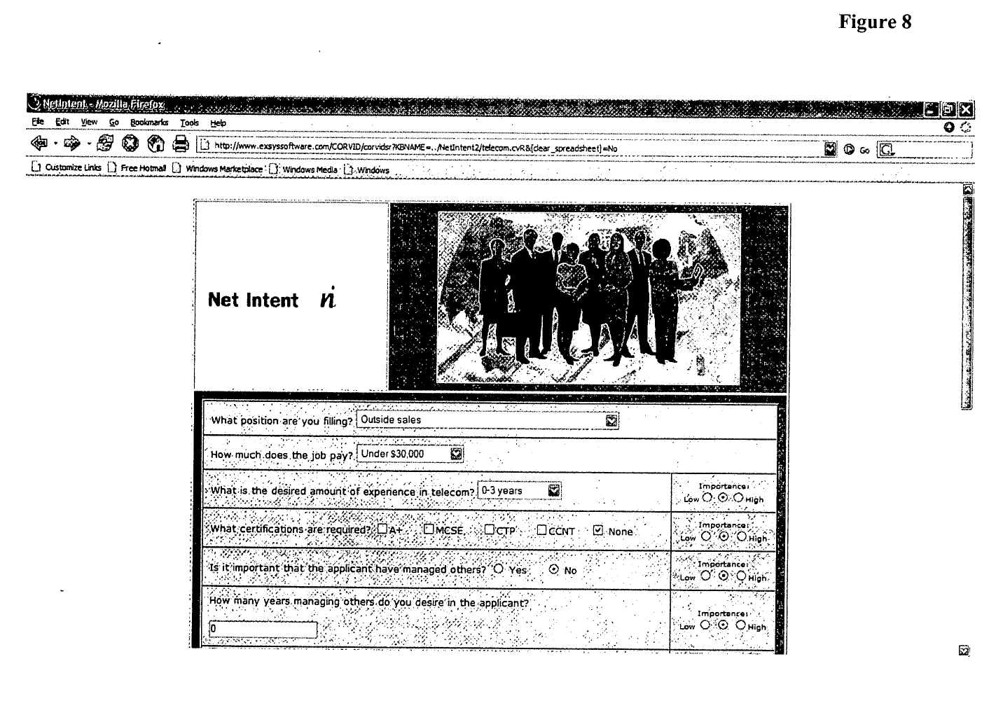

FIG. 8 shows a screen shot of a portion of a “dashboard” or control panel for selecting and setting the ideal profile characteristics for a given set of selection profile factors. This panel is presented to the user as part of the user interface (FIG. 1, 210) permitting input of selection profile factors 110, factor weights, and other user commands 122. As seen in FIG. 8, first, the user identifies position and pay, then selects for each profile selection factor, the ideal characterstics/attributes from a dropdown list. Next, for each profile factor, the user can select low, middle or high weighting of the score. The weighting factors may be assigned any suitable values, such as: low=0.5, middle=1.0 and high=2.0, or low=0.25, middle=1.0 and high=3.0. To make a weighting selection, the user simply needs to understand that one factor will have a multiple of the weight of another factor.

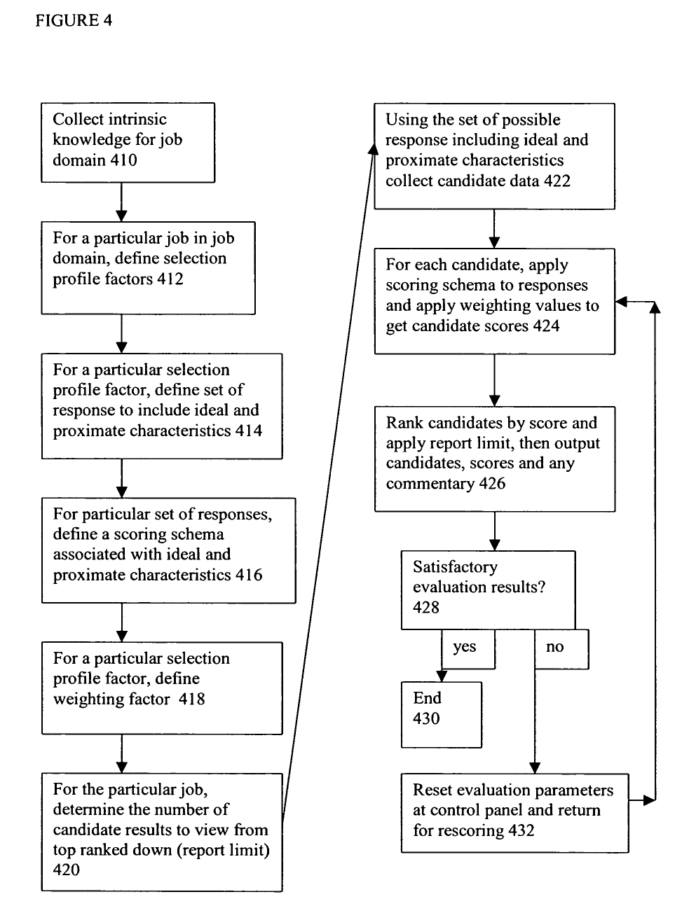

Methods and Interactions. The process of setting up the evaluation of candidates for a particular job position generally follows the steps set forth in FIG. 4. First, the hiring party and/or persons assisting in system building collect intrinsic knowledge for at least one job domain 410, including particular candidate selection profile factors, the range of candidate characteristics typically encountered for each factor and their value in one or more jobs for which candidate evaluation may occur. To set up evaluation of candidates for a particular job in the job domain, the hiring party/system builder defines a set of selection profile factors 412. For each particular selection profile factor, the hiring party/system builder defines a set of responses to include ideal and non-ideal, proximate characteristics 414. For a particular set of responses, it is then necessary to define a scoring schema that associates a scoring value with the ideal and proximate characteristics 416. As noted, much of this may be done by experts in advance of any particular job definition and offering to candidates. For each particular selection profile factor, it is also necessary to define a weighting factor 418. Then, for the particular job, the hiring party determines the number of candidate results to view, from the top-ranked candidate down to the report limit 420. The report limit (which may be offered as a selection on the control panel of FIG. 8) may be as few as three or four, or may include ten or fifteen, or even more, if the candidate pool is large and the reviewer has time and resources to review many candidates.

With this foundation the solicitation of candidates (or accessing of a file of candidate responses already received) can begin. To provide data that is useful input, the candidates must submit data that corresponds to the defined evaluation schema. Using the defined set of possible responses, including ideal and proximate characteristics, the hiring party collects candidate data 422. Electronic solicitation of responses is highly efficient and may be effected with an appropriate candidate data interface 220 (FIG. 1). (For example, an interview via an on-line form may be used.) Electronic data is immediately available for analysis; however, paper instruments (data captured by scanning or other suitable entry means) may also be used to collect candidate information for evaluation. Once the candidate pool is sufficiently populated (and may be closed), for each candidate the system accesses the candidate data and applies the scoring schema to candidate responsive characteristics and applies weighting values to get a candidate total score 424. This can be expressed as a raw number or as a percentage of the maximum possible score for the ideal candidate. With multiple candidate total scores computed, the system can rank candidates by total score and apply the report limit to select those to be reviewed. The system then outputs these candidates, in a stacked or ordered list with scores and any commentary 426. The report limit may be an adjustable parameter and selectable by the user before or after viewing any output.

If the user feels the results are not satisfactory 428, the user can consider whether parameters in the selection profile and/or weights can be reset to produce better results. If results are satisfactory, the evaluation ends 430. If not, the user returns to the control panel (FIG. 8) to reset desired parameters 432 (including the ideal characteristics, weightings) and initiate a fresh application of the revised scoring schema to the candidate data 424. This may be repeated until satisfactory results are obtained.

Data Structures. The use of the system and method of the present invention results in the construction of certain data structures to capture intrinsic knowledge that determines evaluation. These may be facilitated by the expert domain input interface 242, using a selection matrix as in FIG. 7. Use of the system also results in the construction of data structures embodying the scoring schemas of FIGS. 3 and 5. These document intrinsic knowledge and provide the basis for numeric and logical evaluation and scoring of candidate data.

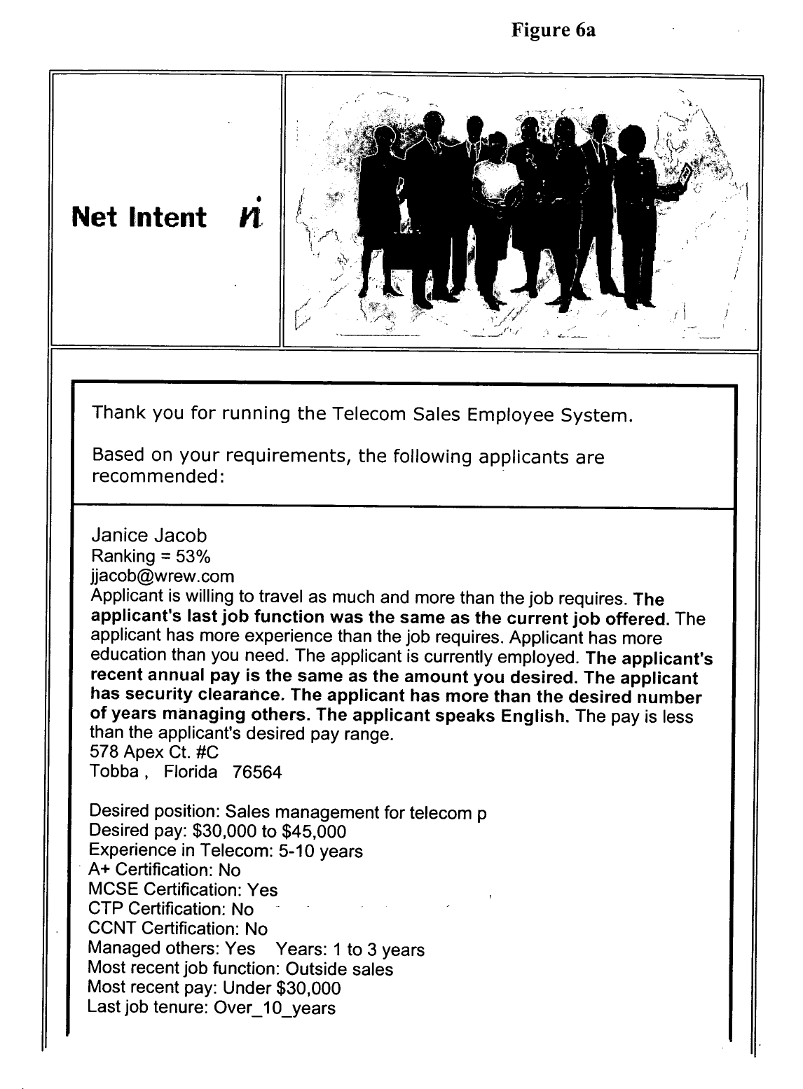

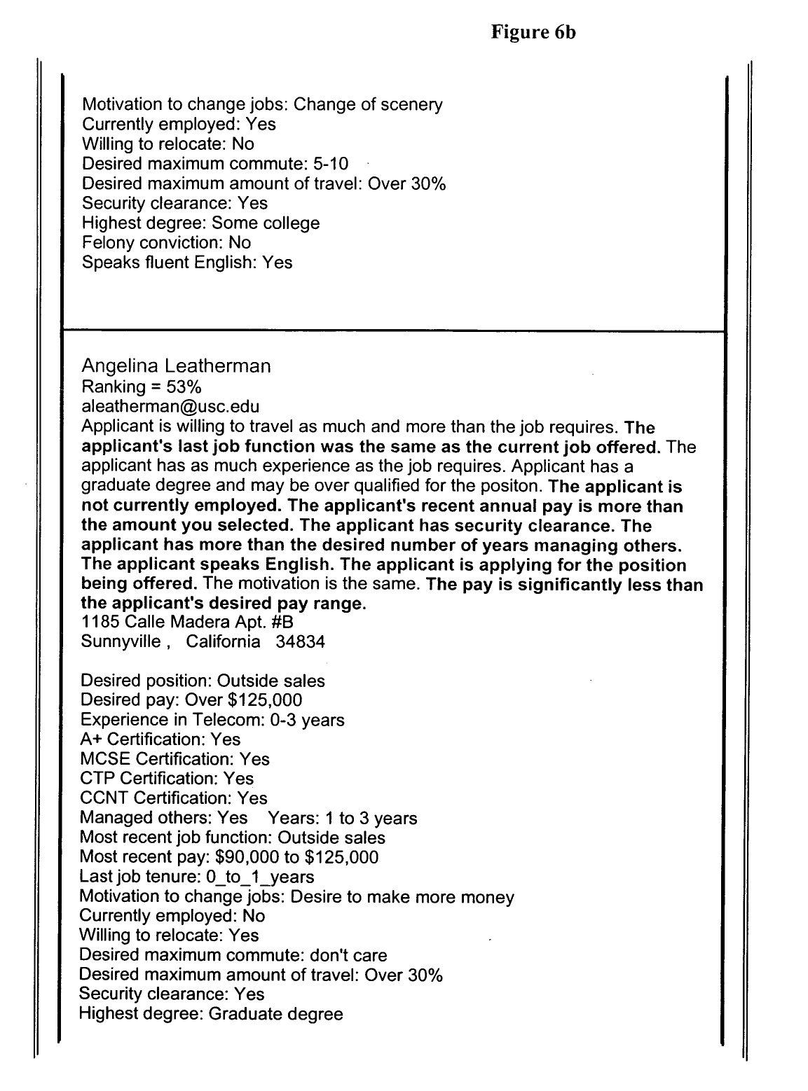

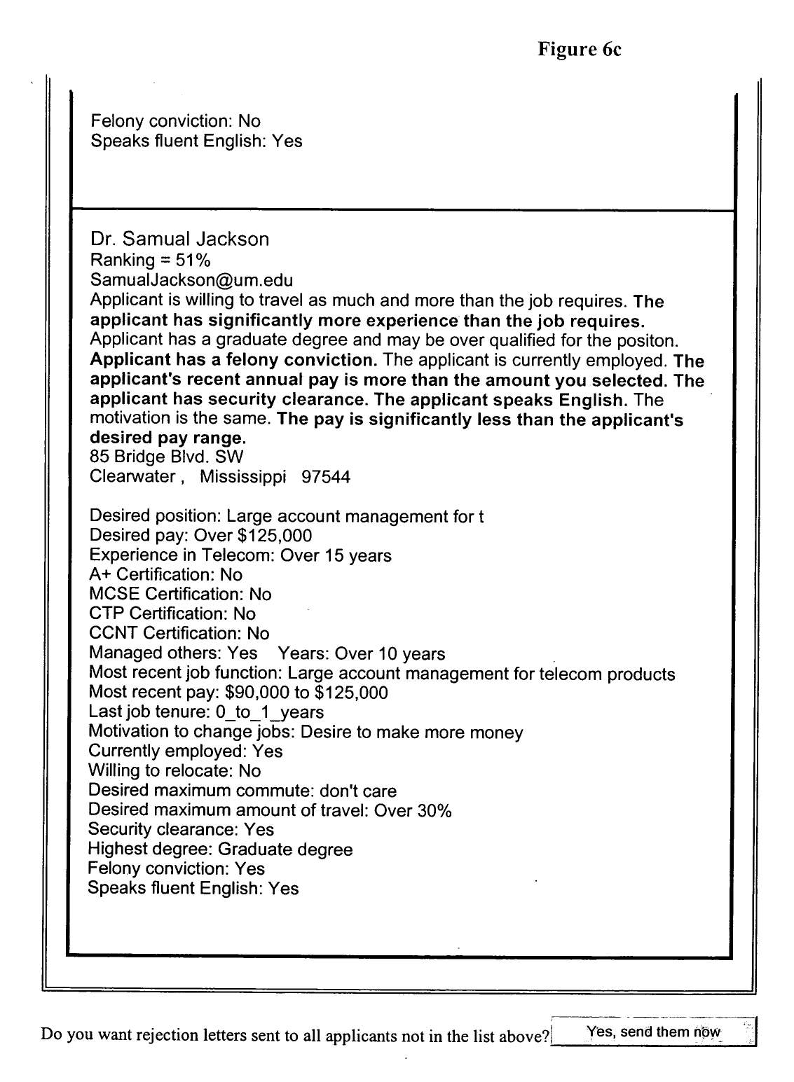

Outputs. Typical output of an evaluation process is shown in FIG. 6. This form of output shows a ranked candidate list 250 (FIG. 1) with percent scores, calculated based on a percentage of the score that would have been obtained by a candidate that got the highest score on each element of the selection profile factors. The particular form of report depicted also includes a brief textual candidate commentary 252 (FIG. 1) that helps explain the proximity measures that may be most significant. For example, the report can make note of those situations where a candidate's response matches the ideal response in the scoring schema. It may also mention factors that would be worthwhile for an interviewer to know in any follow-up contact with a candidate. The report may also provide a summary of actual responses.

Other Applications. The above system and method can also be applied to evaluation of other candidate pools, such as a pool of already hired employees from which the hiring employee wishes to select persons to move or advance to a new position or to whom additional training will be provided. In that case personnel records may supply many of the relevant candidate attributes/characteristics for candidate data 220 ((FIG. 1), making any on-line interview to collect other attributes/characteristics unnecessary or abbreviated. Here the focus of the selection profile factors and the corresponding characteristics comprising the intrinsic knowledge that is built into the scoring schema may be more on data from job evaluations or perhaps results from internally administered assessment instruments. The assessment results can report on measures of team-working aptitude or existing skills that are relevant to evaluation and eventual selection. The selection profile factor and scoring schema are configured to select the best candidates for advancement or training.

The above system and method can also be applied to evaluation of other candidate pools, where the candidates are not individuals but entities such as possible distributors, sales representatives or other business associates. Here the focus of the selection profile factors and the corresponding characteristics comprising the intrinsic knowledge that is built into the scoring schema will be organizational characteristics, such as size, locations, product line experience, certification of technical personnel, involvement with possible competitive or complementary products. Again, because of the multidimensional nature of an evaluation of such entities, the present system can provide a benefit.

Although the present invention has been described with reference to preferred embodiments, persons skilled in the art will recognize that changes may be made in form and detail without departing from the spirit and scope of the invention.

1. A computer implemented system for assisting in evaluating candidates comprising:
a program component defining a plurality of selection profile factors, each with a set of two or more responsive characteristics applicable to a candidate;
a program component defining a scoring schema associated with each set of two or more responsive characteristics, each responsive characteristic having an associated scoring value Sij based on intrinsic knowledge;
a program component for defining a weighting vector containing a weighting value Wi for one or more of the plurality of selection profile factors;
a program component for accessing data representing responsive characteristics of one or more candidates for the plurality of selection profile factors; and
a program component for developing an evaluation of each candidate's responsive characteristics relevant to the selection profile factors, said evaluation comprising determining scoring values associated with the candidate responsive characteristics and applying to the determined scoring values a weighting value corresponding to the selection profile factor, then aggregating for each candidate the resulting weighted scoring values for the responsive characteristics of such candidate.

2. The system of claim 1 wherein the program component for aggregating the resulting weighted scoring values for a candidate comprises a program component for computing the sum of such weighted scoring values and further comprising a program component for ranking the one or more candidates based on the sum of resulting weighted score values for each candidate.

3. The system of claim 1 wherein the program component for defining a weighting vector defines weighting values based on user weighting selections.

4. The system of claim 1 wherein a scoring schema associated with at least one selection profile factor has a range of values that are non-linear.

5. The system of claim 1 wherein a scoring schema associated with at least one selection profile factor contains dependencies responsive to selected responses for another selection profile factor.

6. The system of claim 1 wherein the program component defining a scoring schema has an associated expert domain input interface for receiving expert input to determine the scoring values in the scoring schema.

7. The system of claim 1 further comprising a program component for soliciting responses from one or more candidates, with the candidates selecting responsive characteristics relevant to the selection profile factors.

8. The system of claim 1 wherein the candidates are candidates selected from the group consisting of job candidates, advancement candidates, training candidates and business associate candidates.

9. The system of claim 1 wherein the intrinsic knowledge is embodied in the form of a matrix defining proximity measures relative to an ideal responsive characteristic.

10. The system of claim 1 further comprising a program component for selecting and reselecting elements in a scoring schema applied by the program component for developing an evaluation.

11. A computer implemented method for assisting in evaluating candidates comprising:
defining a plurality of selection profile factors, each with a set of two or more responsive characteristics applicable to a candidate;
defining a scoring schema associated with each set of two or more responsive characteristics, each responsive characteristic having an associated scoring value Sij based on intrinsic knowledge;
defining a weighting vector containing a weighting value Wi for one or more of the plurality of selection profile factors;
accessing data representing responsive characteristics of one or more candidates for the plurality of selection profile factors; and
developing an evaluation of each candidate's responsive characteristics relevant to the selection profile factors, said evaluation comprising determining scoring values associated with the candidate responsive characteristics and applying to the determined scoring values a weighting value corresponding to the selection profile factor, then aggregating for each candidate the resulting weighted scoring values for each responsive characteristic of such candidate.

12. The method of claim 11 wherein the step of aggregating the resulting weighted scoring values for a candidate comprises computing the sum of such weighted scoring values and further comprising ranking the one or more candidates based on the sum of resulting weighted score values for each candidate.

13. The method of claim 11 wherein the step of defining a weighting vector defines weighting values based on user weighting selections.

14. The method of claim 11 wherein a scoring schema associated with at least one selection profile factor has a range of values that are non-linear.

15. The method of claim 11 wherein a scoring schema associated with at least one selection profile factor contains dependencies responsive to selected responses for another selection profile factor.

16. The method of claim 11 wherein the step of defining a scoring schema has an associated expert domain input interface for receiving expert input to determine the scoring values in the scoring schema.

17. The method of claim 11 further comprising soliciting responses from one or more candidates, with the candidates selecting responsive characteristics relevant to the selection profile factors.

18. The method of claim 11 wherein the candidates are candidates selected from the group consisting of job candidates, advancement candidates, training candidates and business associate candidates.

19. The method of claim 11 wherein the intrinsic knowledge is embodied in the form of a matrix defining proximity measures relative to an ideal responsive characteristic.

20. The method of claim 11 further comprising selecting and reselecting elements in a scoring schema applied by the program component for developing an evaluation.

21. A computer readable medium having stored therein a computer program for assisting in evaluating candidates comprising:
a program component defining a plurality of selection profile factors, each with a set of two or more responsive characteristics applicable to a candidate;
a program component defining a scoring schema associated with each set of two or more responsive characteristics, each responsive characteristic having an associated scoring value Sij based on intrinsic knowledge;
a program component for defining a weighting vector containing a weighting value Wi for one or more of the plurality of selection profile factors;
a program component for accessing data representing responsive characteristics of one or more candidates for the plurality of selection profile factors; and
a program component for developing an evaluation of each candidate's responsive characteristics relevant to the selection profile factors, said evaluation comprising determining scoring values associated with the candidate responsive characteristics and applying to the determined scoring values a weighting value corresponding to the selection profile factor, then aggregating for each candidate the resulting weighted scoring values for each responsive characteristics of such candidate.

22. The medium of claim 21 wherein the program component for aggregating the resulting weighted scoring values for a candidate comprises a program component for computing the sum of such weighted scoring values and further comprising a program component for ranking the one or more candidates based on the sum of resulting weighted score values for each candidate.

23. The medium of claim 21 wherein the program component for defining a weighting vector defines weighting values based on user weighting selections.

24. The medium of claim 21 wherein a scoring schema associated with at least one selection profile factor has a range of values that are non-linear.

25. The medium of claim 21 wherein a scoring schema associated with at least one selection profile factor contains dependencies responsive to selected responses for another selection profile factor.

26. The medium of claim 21 wherein the program component defining a scoring schema has an associated expert domain input interface for receiving expert input to determine the scoring values in the scoring schema.

27. The medium of claim 21 further comprising a program component for soliciting responses from one or more candidates, with the candidates selecting responsive characteristics relevant to the selection profile factors.

28. The medium of claim 21 wherein the candidates are candidates selected from the group consisting of job candidates, advancement candidates, training candidates and business associate candidates.

29. The medium of claim 21 wherein the intrinsic knowledge is captured in the form of a matrix defining proximity measures relative to an ideal responsive characteristic.

30. The medium of claim 21 further comprising a program component for selecting and reselecting elements in a scoring schema applied by the program component for developing an evaluation.
